(19) United States
(12) Patent Application Publication
(10) Pub. No.: US 2017/0124563 A1
(43) Pub. Date: May 4, 2017

(54) ACCOUNT IDENTIFIER USED FOR CREDITING

(71) Applicant: NCR Corporation, Duluth, GA (US)

(72) Inventor: VLADYSLAV HRYBOK, ATLANTA, GA (US)

(21) Appl. No.: 14/927,707

(22) Filed: Oct. 30, 2015

(51) Int. Cl. G06Q 20/40; G06Q 20/24; G06Q 20/10; G06Q 20/34

(52) U.S. Cl. CPC G06Q 20/409; G06Q 20/34; G06Q 20/24; G06Q 20/10

(57) ABSTRACT

The problem of a retailer facing a security risk by storing a credit card number for the purposes of issuing a subsequent refund is addressed by a financial institution issuing at least one identifier associated with an account of a credit card number and useable only for crediting the account. To issue a subsequent refund, the retailer can store the identifier, rather than the credit card number. A hacker would have less incentive to steal such a stored identifier, since the identifier cannot be used for making purchases or withdrawing funds from the account. In some examples, a retailer can receive a credit card number from a customer for a purchase, can transmit the credit card number to the financial institution for authorization, can receive authorization from the financial institution along with the identifier, and can store the identifier for issuing a subsequent refund for the purchase.

### BACKGROUND

Retailers can store credit card numbers for the purposes of issuing subsequent refunds. For instance, when a customer returns an item from a particular purchase, the retailer can identify a stored credit card number associated with the particular purchase, and issue a refund for the returned item to an account associated with the credit card. Such a feature is convenient for the customer making the return, because the customer does not have to provide the credit card that was used for the purchase. Unfortunately, such a feature can pose a security risk for the retailer, because a stored list of credit card numbers can be a prime target for a hacker.

### SUMMARY

The problem of a retailer facing a security risk by storing a credit card number for the purposes of issuing a subsequent refund is addressed by a financial institution issuing at least one identifier associated with an account of a credit card number and useable only for crediting the account. To issue a subsequent refund, the retailer can store the identifier, rather than the credit card number. A hacker would have less incentive to steal such a stored identifier, since the identifier cannot be used for making purchases or withdrawing funds from the account. In some examples, a retailer can receive a credit card number from a customer for a purchase, can transmit the credit card number to the financial institution for authorization, can receive authorization from the financial institution along with the identifier, and can store the identifier for issuing a subsequent refund for the purchase.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 shows an example of a relationship among an account, an identifier for purchasing and crediting the account, and an identifier for only crediting the account, in accordance with some embodiments.

FIG. 2 shows an example of a relationship among an account, a credit card number, and an identifier, in accordance with some embodiments.

FIG. 3 shows an example of a system used to receive and store an identifier, in accordance with some embodiments.

FIG. 4 shows an example of a method for receiving and storing an identifier, in accordance with some embodiments.

FIG. 5 shows an example of a method for receiving and storing an identifier, in accordance with some embodiments.

FIG. 6 shows a block diagram of an example of a terminal, in accordance with some embodiments.

### DETAILED DESCRIPTION

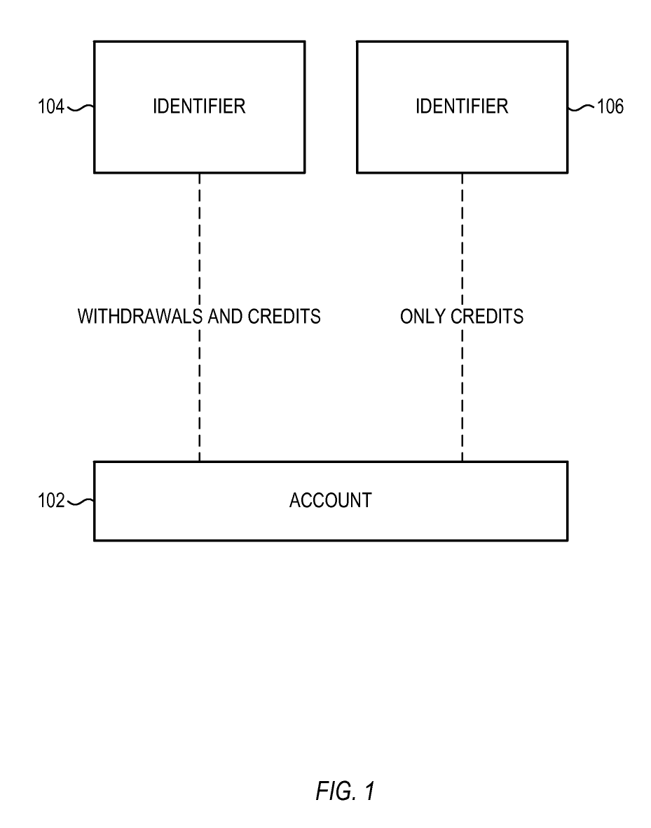

FIG. 1 shows an example of a relationship among an account 102, an identifier 104 for withdrawing from the account and crediting to the account, and an identifier 106 for only crediting to the account, in accordance with some embodiments.

Examples of suitable accounts 102 can include a checking account, a savings account, an account associated with a credit card, an online payment service for electronically transferring funds, an account that can be used for person-to-person transactions, an account that can be used for person-to-business transactions, an account that can be used for business-to-business transactions, an account that can be used for wire transfers, and others.

Identifier 104 can be used to withdraw from the account and can be used to credit to the account. Identifier 104 can include a number or combination of numbers, such as the account numbers that are currently used to identify particular accounts. Examples of suitable identifiers 104 can include an account number, a combination of a routing number and account number (such as the numbers that appear in specified locations on checks), a credit card number, an email addresses that can be used to access a corresponding online payment service, and others. Each of these identifiers 104 can be used to withdraw funds from the corresponding account 102, so each of these identifiers carries the same security risk as a typical credit card number. In general, banks, retailers, and service providers expend great effort to ensure that any lists of these identifiers 104 that they maintain are securely guarded. Examples discussed below use a credit card number as a specific example of identifier 104; it will be assumed that other suitable identifiers can also be used.

Unlike identifier 104, identifier 106 can be used only to credit to the account 102. In some examples, identifier 106 can take on the same format as an identifier 104, such as an account number, a combination of a routing number and account number, a credit card number, an email address, and so forth. In some examples, a financial institution, such as a bank or credit card company, can issue identifier 106 along with identifier 104, so that an account holder can distribute identifier 106 to retailers and/or service providers, as needed, for cases in which the retailer and/or service provider may credit the account, such as for refunds. A list of such identifiers 106 would be of little values to a hacker, because the hacker could not use any of the identifiers 106 to make purchases.

In some examples, identifier 106 can have a durable, quasi-permanent nature. For instance, a financial institution can issue identifier 106 as a credit card number, which can be used for multiple transactions across multiple retailers and/or service providers. As with typical credit card numbers, a credit-only credit card number, issued as identifier 106, can expire after a number of years at a predetermined expiration date. The predetermined expiration date may be independent of any particular transaction performed with the identifier 106 (e.g., one year after a particular purchase). The financial institution can issue a new identifier 106, in the same manner that it issues a new credit card number to replace one that has expired.

In some examples, a financial institution can issue a single identifier 106 for a particular account 102, so that the single identifier 106 can be used across multiple retailers and/or service providers. In other examples, a financial institution can issue multiple identifiers 106 for a particular account 102. For instance, one identifier 106 can be issued for each retailer and/or service provider, so that each retailer can store a single identifier 106 that can be used for multiple transactions at the retailer. In subsequent examples, it will be assumed that the identifier 106 can be used in a manner similar to a typical credit card number, so that identifier 106 can be used for multiple transactions, across multiple retailers and/or service providers.

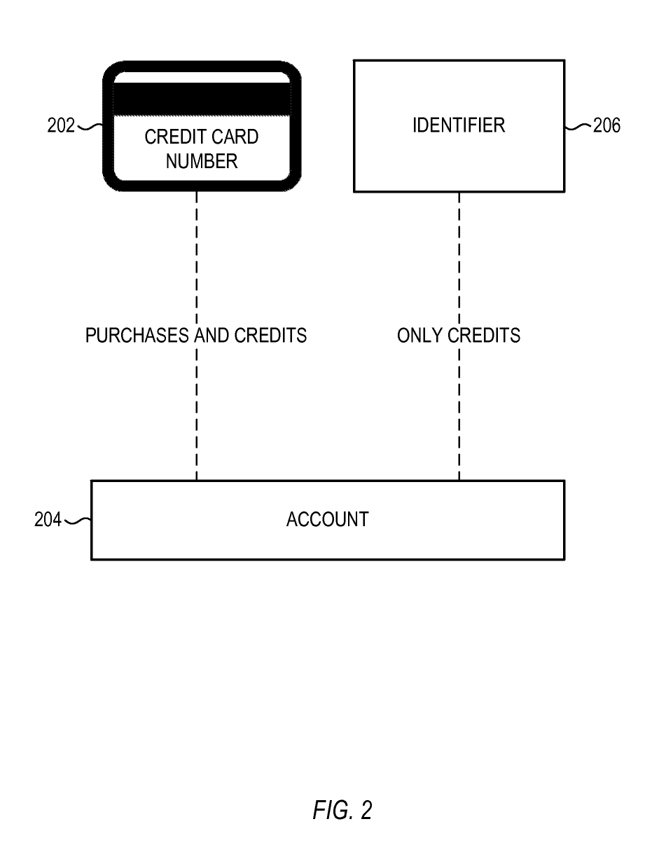

FIG. 2 shows an example of a relationship among a credit card number 202, an account 204, and an identifier 206, in accordance with some embodiments.

A financial institution, such as a bank, credit union, or credit card company, can issue a credit card number 202 to a customer. In some examples, the credit card number 202 can be printed on a physical credit card and encoded on the card, such as in a magnetic strip or in a radiofrequency identification (RFID) tag. In some examples, a card reader can decode the credit card number from the credit card. In some examples, the credit card number can be used to make purchases, such as in person by using the credit card with a card reader, by telephone by dictating the credit card number, or over the internet by entering the credit card number into a suitable field on a web page. The credit card number 202 can also be used to receive credits, such as refunds for one or more purchased items.

The financial institution (or another suitable financial institution) can maintain an account 204 associated with the credit card number 202. When the credit card number 202 is used to make a purchase, the financial institution pays for the purchase and keeps track of the amount of the purchase. The financial institution can bill the owner of the account 204 periodically, such as monthly, to cover the amount of purchases made over a particular time frame, such as the previous month, plus fees paid to the financial institution. In some examples, the account 204 can be linked to a checking or savings account of the owner of the account 204, which can simplify payment for the account owner. When the credit card number is used to receive a refund, the financial institution can record the amount, and can issue a credit to the account owner or deduct the credited amount from the amount owed to the financial institution for purchases.

A retailer can maintain its own list of credit card numbers, in order to simplify the retailer's return procedures for merchandise purchased with a credit card. The list can be stored as a database on a server owned or operated by the retailer, or on a centralized or cloud-based server owned or operated by the retailer. The list of credit card numbers can be valuable for a hacker, who could steal the list and subsequently be able to make purchases with the stolen credit card numbers. A retailer can expend significant effort and cost ensuring the security of such a valuable list.

As an alternative to storing and securing valuable lists of credit card numbers, a financial institution can issue one or more identifiers 206 associated with the account 204 of the credit card number 202. In some examples, an identifier 206 can be a deposit-only credit card number. The identifier 206 is useable only for crediting to the account 204, and cannot be used to make purchases or withdraw from the account 204. To issue a subsequent refund, the retailer can store the identifier 206, rather than the credit card number 202. A hacker would have less incentive to steal a list of such identifiers 206, since the identifiers 206 cannot be used for making purchases or withdrawing funds from the respective accounts 204.

In some examples, each identifier 206 can be uniquely associated with an account 204, so that the same identifier 206 can be sent to multiple retailers. In other examples, each identifier 206 can be uniquely associated with a retailer, so that each retailer can receive and store its own identifier for a particular account 204, and can use the stored identifier 206 for multiple transactions associated with the account.

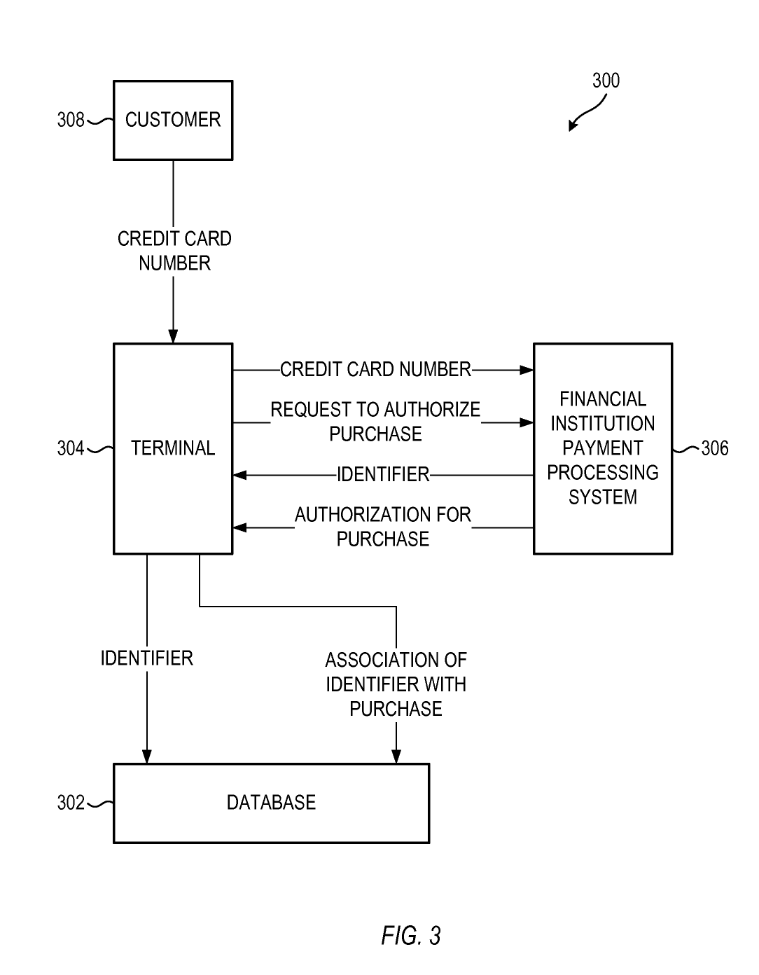

FIG. 3 shows an example of a system 300 used to receive and store an identifier, in accordance with some embodiments.

System 300 can include a database 302 associated with a retailer. Such a database 302 can be stored on a server owned or operated by the retailer, or stored on a centralized or cloud-based server accessible by the retailer.

A terminal 304 can electronically communicate with the database 302, such as through one or more wired and/or wireless connections. In some examples, the terminal can be a payment terminal in a retail or service establishment. In some examples, the terminal can include a card reader, which can accept credit card numbers through a swipe or from a chip. In other examples, the terminal can be a computer, tablet, or smart phone. In some examples, the terminal can receive credit card numbers through a card reader connected to the computer, tablet, or smart phone. In some examples, the terminal can receive credit card numbers through a keypad or a touch-sensitive screen.

Terminal 304 can be configured to receive, for a purchase transaction, a credit card number associated with an account. In some examples, terminal 304 can read the credit card number from a physical credit card, such as with a card reader. In other examples, terminal 304 can receive the credit card number electronically, such as through entry on a website or entry through a telephone-based system.

Terminal 304 can be configured to transmit, to a financial institution payment processing system 306, the credit card number and a request to authorize the purchase transaction. Examples of financial institutions can include a bank, credit union, credit card company, and others. The financial institution payment processing system 306 can be a computer system associated with the financial institution and configured to electronically conduct transactions associated with accounts held at the financial institution.

Terminal 304 can be configured to receive, from the financial institution payment processing system 306, an authorization of the purchase transaction and an identifier associated with the account and useable only for crediting to the account. In some examples, the identifier is uniquely associated with the account. In some examples, the identifier is uniquely associated with a retailer associated with a retailer transaction processing system.

Terminal 304 can be configured to store, in a database 302, the identifier but not the credit card number, and an association of the identifier with a transaction identifier of the purchase transaction. Explicitly not storing the credit card number reduces a security risk for the retailer or service provider, which is desirable. The database can be associated with a retailer transaction processing system and can store the identifier for retrieval for a subsequent crediting to the account associated with the purchase transaction.

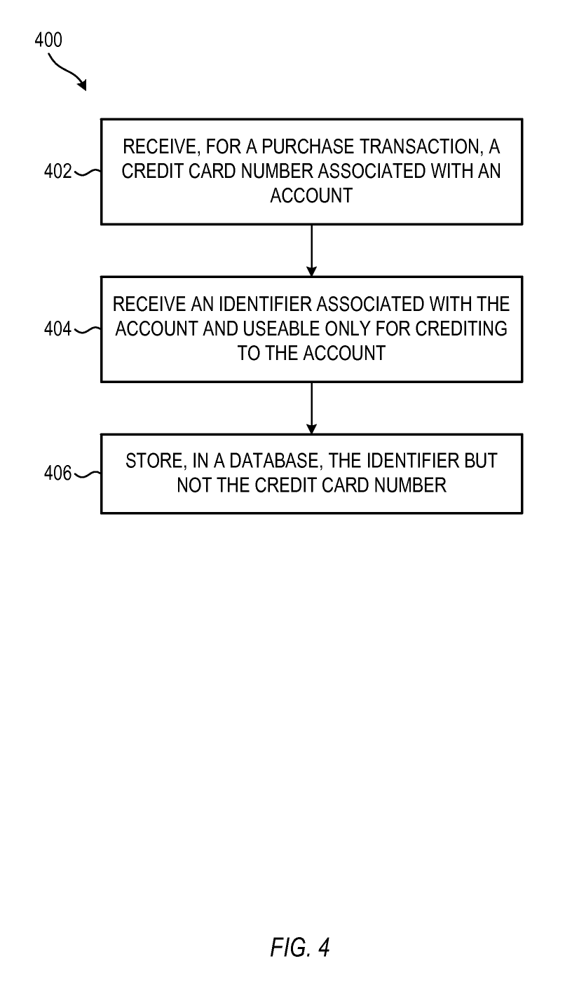

FIG. 4 shows an example of a method 400 for receiving and storing an identifier, in accordance with some embodiments. The method 400 can be executed on a system, such as 300 (FIG. 3), on a terminal, or on other suitable computational devices. This is but one example of a method for receiving and storing an identifier; other suitable methods can also be used.

At operation 402, the system can receive, for a purchase transaction, a credit card number associated with an account.

At operation 404, the system can receive an identifier associated with the account and useable only for crediting to the account.

At operation 406, the system can store, in a database, the identifier but not the credit card number. In some examples, the database can be associated with a retailer transaction processing system and can store the identifier for retrieval for a subsequent crediting to the account associated with the purchase transaction. In some examples, the system can further store, in the database, an association of the identifier with a transaction identifier of the purchase transaction.

In some examples, method 400 can optionally further include transmitting, to a financial institution payment processing system, the credit card number. In some examples, receiving the identifier associated with the account and useable only for crediting to the account can include receiving the identifier from the financial institution payment processing system. In some examples, method 400 can optionally further include transmitting, to the financial institution payment processing system, along with the credit card number, a request to authorize the purchase transaction. In some examples, method 400 can optionally further include receiving, from the financial institution payment processing system, along with the identifier, an authorization of the purchase transaction.

In some examples, the identifier can be uniquely associated with the account, so that each identifier can be used for transactions with multiple retailers and/or service providers. In some examples, the identifier can be uniquely associated with a retailer associated with the retailer transaction processing system, so that each identifier can be used for transactions with a single retailer and/or service provider.

In some examples, receiving, for the purchase, the credit card number associated with the account can include reading the credit card number from a physical credit card, or from another suitable physical medium, such as a wearable physical medium, such as a watch, ring, bracelet, and so forth. In some examples, receiving the identifier associated with the account and useable only for crediting the account can include reading the identifier from the physical credit card. In some examples, the identifier can be uniquely associated with the account.

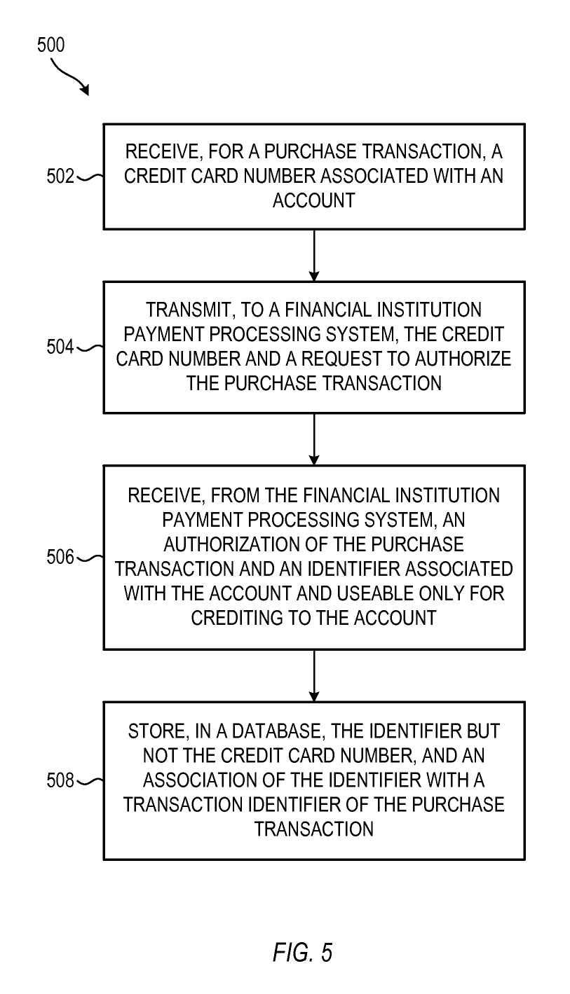

FIG. 5 shows another example of a method 500 for receiving and storing an identifier, in accordance with some embodiments. Method 500 can be executed on a system, such as 300 (FIG. 3), on a terminal, or on other suitable computational devices. This is but one example of a method for receiving and storing an identifier; other suitable methods can also be used.

At operation 502, the system can receive, for a purchase transaction, a credit card number associated with an account.

At operation 504, the system can transmit, to a financial institution payment processing system, the credit card number and a request to authorize the purchase transaction.

At operation 506, the system can receive, from the financial institution payment processing system, an authorization of the purchase transaction and an identifier associated with the account and useable only for crediting to the account.

At operation 508, the system can store, in a database, the identifier but not the credit card number, and an association of the identifier with a transaction identifier of the purchase transaction. The database can be associated with a retailer transaction processing system and stores the identifier for retrieval for a subsequent crediting to the account associated with the purchase transaction.

In some examples, the identifier is uniquely associated with the account, so that each identifier can be used for transactions with multiple retailers and/or service providers. In some examples, the identifier is uniquely associated with a retailer associated with a retailer transaction processing system, so that each identifier can be used for transactions with a single retailer and/or service provider.

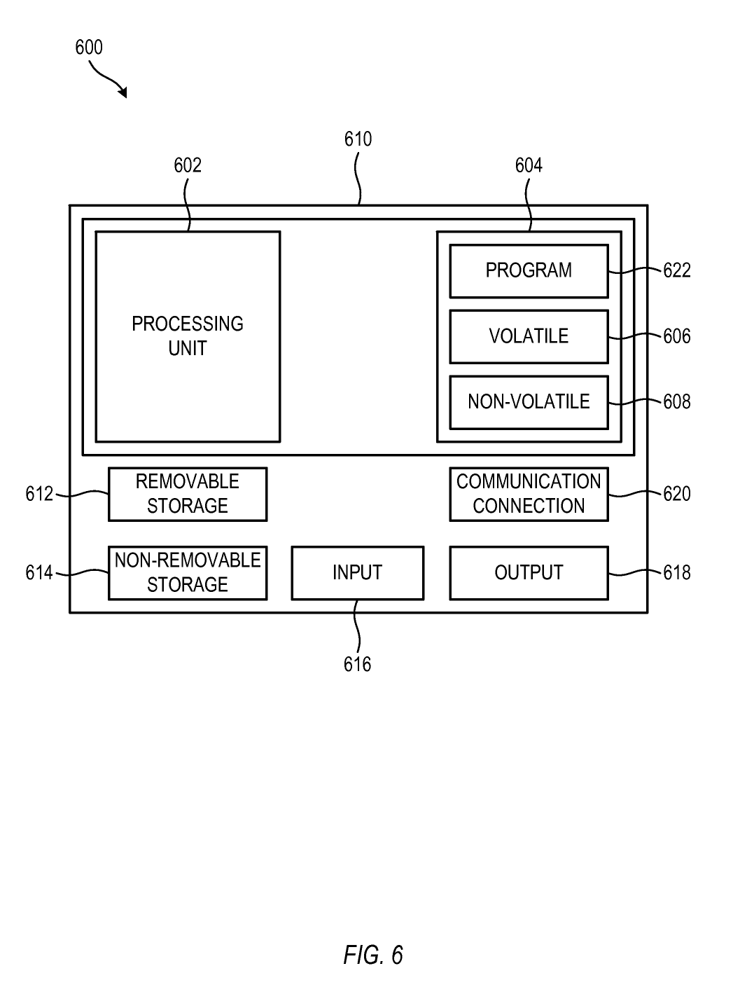

FIG. 6 shows a block diagram of an example of a terminal 600, in accordance with some embodiments. The example of FIG. 6 is but one configuration for a terminal; other configurations can also be used.

In one embodiment, multiple such terminals 600 are utilized in a distributed network to implement multiple components in a transaction based environment. An object-oriented, service-oriented, or other architecture may be used to implement such functions and communicate between the multiple terminals 600 and components.

One example of a terminal 600, in the form of a computer 610, can include a processing unit 602, memory 604, removable storage 612, and non-removable storage 614. Memory 604 may include volatile memory 606 and non-volatile memory 608. Computer 610 may include, or have access to a computing environment that includes, a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) and electrically erasable programmable read-only memory (EEPROM), flash memory or other memory technologies, compact disc read-only memory (CD-ROM), Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment that includes input 616, output 618, and a communication connection 620. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 602 of the computer 610. A hard drive, CD-ROM, and RAM are some examples of articles including a non-transitory computer-readable medium. For example, a computer program 622 with instructions for the computer 610, according to the teachings of the present disclosure, may be included on a CD-ROM and loaded from the CD-ROM to a hard drive. The computer-readable instructions allow computer 610 to provide generic access controls in a COM based computer network system having multiple users and servers.

What is claimed is:

1. A method, comprising:
receiving, for a purchase transaction, a first identifier associated with an account and useable for withdrawing from the account and crediting to the account;
receiving a second identifier associated with the account and useable only for crediting to the account; and
storing, in a database, the second identifier but not the first identifier.

2. The method of claim 1, wherein the first identifier is a credit card number.

3. The method of claim 2, wherein the database is associated with a retailer transaction processing system and stores the second identifier for retrieval for a subsequent crediting to the account associated with the purchase transaction.

4. The method of claim 3, further comprising:
storing, in the database, an association of the second identifier with a transaction identifier of the purchase transaction.

5. The method of claim 2, further comprising:
transmitting, to a financial institution payment processing system, the credit card number.

6. The method of claim 5, wherein receiving the second identifier associated with the account and useable only for crediting to the account comprises:
receiving the second identifier from the financial institution payment processing system.

7. The method of claim 6, further comprising:
transmitting, to the financial institution payment processing system, along with the credit card number, a request to authorize the purchase transaction.

8. The method of claim 7, further comprising:
receiving, from the financial institution payment processing system, along with the second identifier, an authorization of the purchase transaction.

9. The method of claim 5, wherein the second identifier is uniquely associated with the account.

10. The method of claim 5, wherein the second identifier is uniquely associated with a retailer associated with the retailer transaction processing system.

11. The method of claim 2, wherein receiving, for the purchase transaction, the first identifier associated with the account and useable for withdrawing from the account and crediting to the account comprises:
reading the credit card number from a physical credit card.

12. The method of claim 11, wherein receiving the second identifier associated with the account and useable only for crediting the account comprises:
reading the identifier from the physical credit card.

13. The method of claim 12, wherein the identifier is uniquely associated with the account.

14. The method of claim 1, wherein the second identifier is a deposit-only credit card number.

15. A method, comprising:
receiving, for a purchase transaction, a credit card number associated with an account;
transmitting, to a financial institution payment processing system, the credit card number and a request to authorize the purchase transaction;
receiving, from the financial institution payment processing system, an authorization of the purchase transaction and an identifier associated with the account and useable only for crediting to the account; and
storing, in a database, the identifier but not the credit card number, and an association of the identifier with a transaction identifier of the purchase transaction,
wherein the database is associated with a retailer transaction processing system and stores the identifier for retrieval for a subsequent crediting to the account associated with the purchase transaction.

16. The method of claim 15, wherein the identifier is uniquely associated with the account.

17. The method of claim 15, wherein the identifier is uniquely associated with a retailer associated with the retailer transaction processing system.

18. A system, comprising:
a database associated with a retailer;
a terminal in electronic communication with the database, the terminal being configured to:
receive, for a purchase transaction, a credit card number associated with an account;
transmit, to a financial institution payment processing system, the credit card number and a request to authorize the purchase transaction;
receive, from the financial institution payment processing system, an authorization of the purchase transaction and an identifier associated with the account and useable only for crediting to the account; and
store, in a database, the identifier but not the credit card number, and an association of the identifier with a transaction identifier of the purchase transaction,
storing, in the database, the identifier but not the credit card number, and an association of the identifier with the purchase;
wherein the database is associated with a retailer transaction processing system and stores the identifier for retrieval for a subsequent crediting to the account associated with the purchase transaction.

19. The system of claim 18, wherein the identifier is uniquely associated with the account.

20. The system of claim 18, wherein the identifier is uniquely associated with a retailer associated with the retailer transaction processing system.
